(19) United States
(12) Patent Application Publication
(10) Pub. No.: US 2006/0232419 A1
(43) Pub. Date: Oct. 19, 2006

(54) RFID tag and antenna arranging method

(75) Inventors: Takeshi Tomioka, Kawasaki (JP); Takanao Ochiai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/283,921

(22) Filed: Nov. 22, 2005

(30) Foreign Application Priority Data
Apr. 13, 2005 (JP) 2005-116142

(51) Int. Cl. G08B 13/14

(52) U.S. Cl. 340/572.7

(57) ABSTRACT

A non-contact integrated circuit (IC) tag accepts a plurality of frequency bands and provides sufficient performance in a compact size by freely arranging a plurality of antennas therein such that the antennas occupy a minimum area and by preventing interference between the antennas with an insulator.

### CROSS-REFERENCE TO RELATED APPLICATIONS

This application claims the benefit of Japanese Application No. 2005-116142, filed Apr. 13, 2005, in the Japan Patent Office, the disclosure of which is incorporated herein by reference.

### BACKGROUND OF THE INVENTION

1. Field of the Invention

The present invention relates to a radio frequency identification (RFID) tag provided with a plurality of antennas, and a method of arranging the antennas in the RFID tag. More specifically, the present invention relates to an RFID tag that accepts a plurality of frequency bands and provides sufficient performance in a compact size, and an antenna arranging method thereof.

2. Description of the Related Art

In recent years, RFID tags are garnering attention as a product identification technology that can replace conventional barcode functions. It is expected that this technology will not only replace the barcode functions, but also drastically innovate conventional methods of physical distribution management, to improve efficiency. The RFID tags include a compact-sized integrated circuit (IC) chip and an antenna that are stored together inside a medium, such as a card. The RFID tags read/write information from/in a reader/writer, in a non-contact manner, through electromagnetic fields or electric waves. Moreover, passive-type RFID tags do not have built-in batteries because they use the electromagnetic fields or the electric waves transmitted from the reader/writer as a power source of the IC chip. Therefore, the passive-type RFID tags can be thin and compact.

There are various frequency bands used by the passive-type RFID tags, each having different characteristics. For example, a microwave band of 2.45 gigahertz (GHz) can realize relatively long-haul communication. However, the 2.45 GHz microwave band is also used as an industrial, scientific, and medical (ISM) band by communication devices other than RFID devices, microwave ovens, and so forth. Therefore, in an environment installed with these devices, communication performance can be largely affected and deteriorated. Moreover, the 2.45 GHz microwave band has a characteristic of being absorbed by moisture. Thus, in a moist environment, communication range between the RFID tags and the reader/writer can become unstable.

A high frequency (HF) band of 13.56 megahertz (MHz) uses a communication method of electromagnetic induction by electromagnetic fields. The 13.56 MHz HF band has a short communication range and is thus unlikely to be affected by moisture. However, the 13.56 MHz HF band is largely affected by metal objects, which leads to a significant decrease in the communication range or a communication failure. An ultra high frequency (UHF) band of 950 MHz to 956 MHz can realize long-haul communication, similarly to the microwave band. However, because the UHF band uses electric waves, communication errors can be caused in a moist environment, although the UHF band is not as susceptible to moisture as the microwave band.

Typically, passive-type RFID tags can only accept a single frequency band. Therefore, in practical environments, these tags cannot always function properly. For example, when the microwave band is used and the tags are wet, the tags cannot communicate with the reader/writer, because electric waves are absorbed by water. Thus, it is very difficult to read/write information. When the HF band is used, and if the object to which the tag is applied is made of metal or a metal object is placed nearby, an antenna of the tag cannot receive a sufficient amount of power from electromagnetic fields generated by the reader/writer. Thus, it is very difficult to read/write information to the passive RFID tag.

To make the RFID tags function properly in various environments, one approach is to make the RFID tags accept a plurality of frequency bands. A technology for making the RFID tags accept a plurality of frequency bands is known in the art. Japanese Patent Application Laid Open No. 2001-28037 discloses a technology for connecting a plurality of antennas in parallel on a surface of a medium of a tag so as to prevent mutual interference, and the connected antennas are stored in a single medium of a certain shape. Non-patent literature 1, “TOPPAN FORMS RFID-ing/from manufacturing RFID tags to system architecture”, [online], Toppan Forms Co., Ltd., [searched on Mar. 25, 2005], Internet: <URL: http://rfid.toppan-f.co.jp/tech/mm/c_mm.html>, discloses a technology for devising the shape of the antenna, so that the RFID tag can accept a plurality of frequency bands with a single antenna.

However, because the technology disclosed in Japanese Patent Application Laid Open No. 2001-28037 requires the plurality of antennas to be connected in parallel, the overall size of the RFID tag increases. This problem needs to be solved in order to reduce the size of the RFID tag. Furthermore, the method of making the RFID tag accept a plurality of frequency bands with a single antenna as described in Non-patent literature 1 also has a problem. Specifically, because the degree of freedom in designing the single antenna is restricted, it is difficult to make the single antenna in an optimal shape suited for the characteristics of each frequency. Thus, sufficient performance is hard to achieve.

Typically, different parameters are required when designing antennas for microwave bands/UHF bands and HF bands. Specifically, in the former case, impedance of input terminals of RFID chips needs to be matched without decreasing antenna gain. In the latter HF case, resonance frequencies need to be matched while adjusting the number of windings of an antenna coil and the size of the antenna, to receive a sufficient amount of power by electromagnetic induction. Thus, a mixture of antennas tuned to different frequencies need to be stored in a single tag, without deteriorating communication performance of each antenna. To achieve this, the antennas need to be compatible with various shapes of tags, without reducing the degree of freedom in the design of the antenna.

### SUMMARY OF THE INVENTION

The present invention provides a passive-type RFID tag that accepts a plurality of frequency bands and provides sufficient performance by not deteriorating communication performance of each antenna in a compact size, and an antenna arranging method thereof where the antennas can be compatible with various shapes of tags, without reducing the degree of freedom in the design of the antennas.

Additional aspects and advantages of the invention will be set forth in part in the description which follows and, in part, will be obvious from the description, or may be learned by practice of the invention.

An RFID tag includes a plurality of antennas and an interference prevention unit that prevents interference between the antennas.

According to an aspect of the present invention, in the RFID tag, the interference prevention unit provides an insulator between the antennas to prevent the interference between the antennas.

According to the aspect of the present invention, in the RFID tag, the insulator is made of insulating resin.

According to an aspect of the present invention, in the RFID tag, the resin is polyethylene terephthalate.

According to an aspect of the present invention, in the RFID tag, the insulator is at least 2 mm thick.

According to an aspect of the present invention, in the RFID tag, the insulator is made of ceramics.

According to an aspect of the present invention, in the RFID tag, the insulator is made of insulating paper.

According to an aspect of the present invention, in the RFID tag, the interference prevention unit coats at least one of the antennas with a material that transmits electromagnetic waves of a frequency band to be transmitted and received by the corresponding antenna, to prevent the interference between the antennas.

A method of arranging antennas in an RFID tag including a plurality of antennas, by providing an insulator between the antennas to prevent interference between the antennas.

A method of arranging antennas in an RFID tag including a plurality of antennas, by coating least one of the antennas with a material that transmits electromagnetic waves of a frequency band to be transmitted and received by the corresponding antenna, to prevent interference between the antennas.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a top view of an RFID tag, according to an embodiment of the present invention.

FIG. 2 is a cross-sectional view of the RFID tag, according to an embodiment of the present invention.

FIG. 3 is a cross-sectional view of the RFID tag, in which antennas are coated to prevent interference of electromagnetic waves, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

According to an aspect of the present invention, interference in a non-contact integrated circuit (IC) tag, for example, in a radio frequency identification (RFID) tag, (hereinafter simply referred to as a “tag,” between antennas is prevented by one or more insulator spacer(s) and/or insulator coating(s). Therefore, a plurality of antennas, each accepting different frequencies, can be freely arranged in a tag, so that the antennas can occupy a minimum area. Thus, for example, an RFID tag that accepts a plurality of frequency bands and provides sufficient performance in a compact size can be provided. The embodiments described herein use a passive RFID tag as an example, but the present invention is not limited to a passive RFID tag and can be applied to any type of non-contact (i.e., electromagnetic field communication) IC data read/writable tag. According to an aspect of the present invention, an RFID tag can be passive, non-passive (active or battery powered), or any combinations thereof (e.g., semi-passive). An RFID tag can support various item or product identification techniques to contain or store information for identifying items or products.

Preferred embodiments of an RFID tag and an antenna arranging method according to the present invention are explained below in detail with reference to the accompanying drawings. In the following embodiments, an RFID tag that accepts three frequency bands, a microwave band (2.45 GHz), a UHF band (860 MHz to 960 MHz), and a HF band (13.56 MHz), is taken as an example. However, the present invention is effective for any other combination of frequency bands.

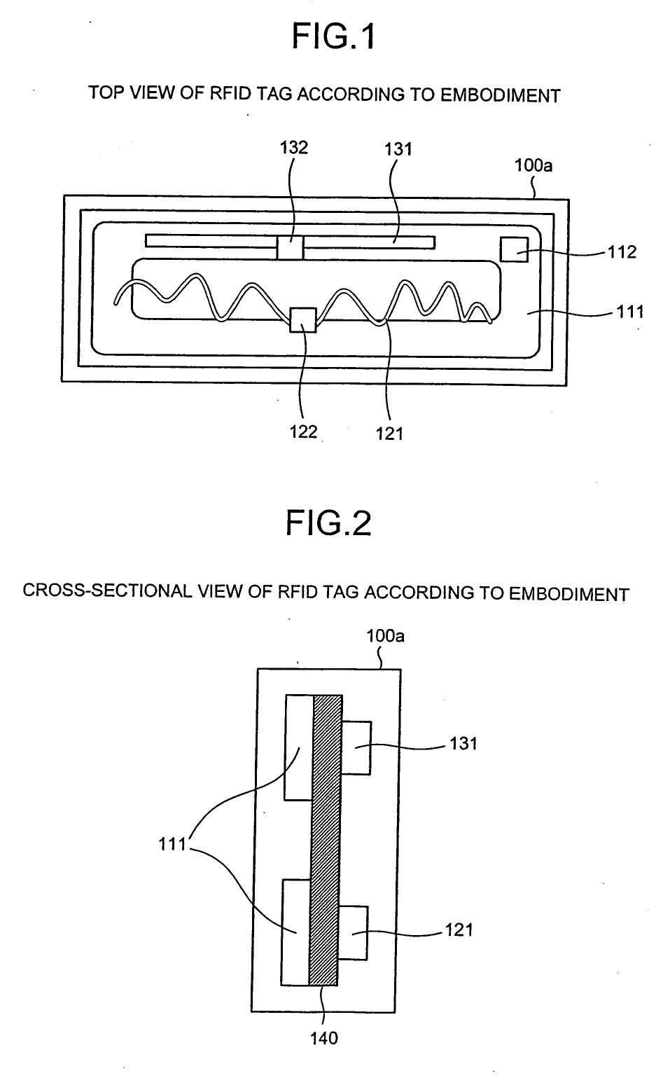

FIG. 1 is a top view of an RFID tag 100a, according to an embodiment of the present invention. The RFID tag 100a includes a coil antenna for the HF band 111, an RFID chip for the HF band 112, a dipole antenna for the UHF band 121, an RFID chip for the UHF band 122, a dipole antenna for the microwave band 131, and an RFID chip for the microwave band 132.

The coil antenna for the HF band 111 has a function of generating power by receiving an electromagnetic field from a reader/writer, and performing electromagnetic induction. The power thus generated is used for operating a circuit inside the RFID chip (e.g., IC chip 112) and transmitting signals. Further, the coil antenna for the HF band 111 has a function of transceiving electromagnetic signals at the tag. The RFID chip for the HF band 112 controls communication through the coil antenna for the HF band 111, and is an IC chip including a non-volatile memory circuit that stores predetermined information. According to an aspect of the invention, for the HF band, a frequency of the electromagnetic field used for communication between the reader/writer and the tag is 13.56 MHz, and resonance frequencies of the tag antennas are adjusted to 13.56 MHz.

The antenna for the UHF band 121 is a dipole antenna in a shape appropriate for transceiving electric waves in the UHF band. The RFID chip for the UHF band 122 controls communication with the reader/writer through the dipole antenna for the UHF band 121, and is an IC chip including a non-volatile memory circuit that stores predetermined information. According to an aspect of the invention, for the UHF band, electric wavelength of the 950 MHz to 956 MHz band is taken into consideration in determining the length of the dipole antenna. The antenna is designed so as to obtain sufficient antenna gain to transceive electric waves in this electric waveband.

The dipole antenna for the microwave band 131 is a dipole antenna in a shape appropriate for transceiving electromagnetic waves in the microwave band. The RFID chip for the microwave band 132 controls communication through the dipole antenna for the microwave band 131, and is an IC chip including a non-volatile memory circuit that stores predetermined information.

As described above, the RFID tag 100a includes three antennas, the coil antenna for the HF band 111, the dipole antenna for the UHF band 121, and the dipole antenna for the microwave band 131. According to an aspect of the present invention, these antennas are not arranged in parallel on/in a tag medium or encasing, but a plurality of antennas (two or more) are superposed on each other inside the same tag, to prevent an increase in size. The present invention is not limited to the superposition described in FIG. 1, and any superpose, or superimpose, arrangement can be used.

When a plurality of antennas is superposed on each other, interference or coupling between the antennas can cause a malfunction. When the antennas are spaced close to each other, the antennas can be electrically coupled, and the coupled capacity appears as the capacity of a single antenna. Thus, in the antennas of the UHF band and the microwave band, the impedance significantly deviates from the previously tuned impedance. Accordingly, power cannot be sufficiently supplied to the circuit(s) in the chip(s). As a result, communication properties of the tag can deteriorate, or the tag might not respond to communication. Also, in the HF band, the resonance frequency of the antenna deviates, and communication performance with the reader/writer can deteriorate significantly. However, in the RFID tag 100a according to the embodiment of the present invention, an insulating spacer is provided between the antennas to solve this problem.

FIG. 2 is a cross-sectional view of the RFID tag 100a, according to an embodiment of the present invention. For example, in the RFID tag 100a, a spacer 140 is arranged between the coil antenna for the HF band 111 and the dipole antenna for the UHF band 121, and between the coil antenna for the HF band 111 and the dipole antenna for the microwave band 131.

The spacer 140 needs to have insulation properties to prevent interference between the antennas or electromagnetic spectrum insulator(s). According to an aspect of the invention, the spacer 140 has a predetermined thickness to prevent interference of electromagnetic waves. The spacer 140 can be made of a material including, for example, polyethylene terephthalate (PET) resin, including any copolymerization(s) thereof, etc. When the spacer 140 is made of resin, it needs to be approximately 2 mm thick or more to prevent interference of electromagnetic waves. The spacer 140 can be made of ceramics or insulating paper, instead of resin. In the described embodiment, a space reserved for the spacer is 2 mm thick. However, the thickness of the spacer 140 can be controlled by changing the dielectric constant of the spacer material. Specifically, the thickness of the spacer 140 can be reduced by decreasing the dielectric constant of the spacer 140 material. According to an aspect of the invention, a plurality of spacers 140 as antenna interference prevention units or insulators can be provided and the spacers 140 can be PET type resin, ceramic, insulating paper, or any combinations thereof.

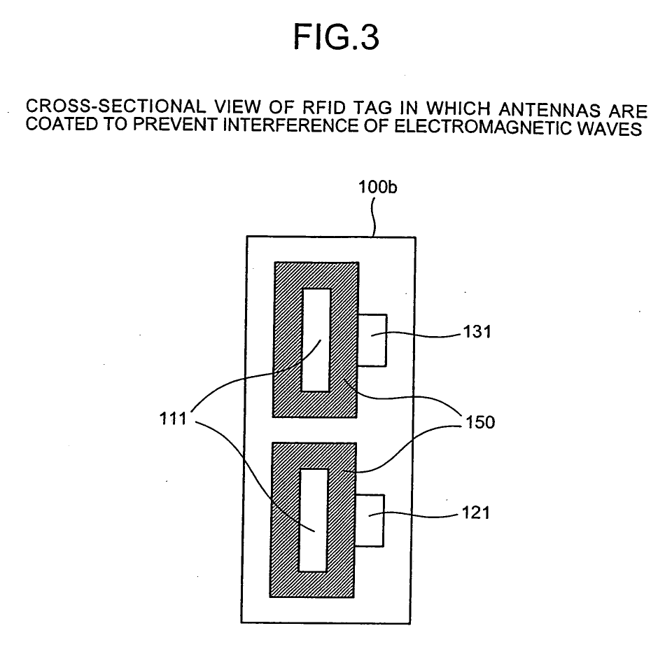

Another effective method of preventing interference of electromagnetic waves besides using a spacer is coating the antennas. FIG. 3 is a cross-sectional view of an RFID tag 100b, in which antennas are coated to prevent interference of electromagnetic waves, according to an embodiment of the present invention. The same antennas as those in the RFID tag 100a are built in the RFID tag 100b. The coil antenna for the HF band 111 is applied with coating 150, so that the HF coil antenna 111 does not directly contact the dipole antenna for the UHF band 121 or the dipole antenna for the microwave band 131. According to an aspect of the invention, coating 150 is made of a material that transmits electromagnetic waves of the frequency band transceived by the coil antenna for the HF band 111, but blocks electromagnetic waves of other frequency bands. According to an aspect of the invention, antenna insulating coating to prevent interference between/among the antennas can be provided on at least one antenna or any combination of the antennas. According to an aspect of the invention, an amount of coating can be controlled according the dielectric constant of coating material.

As described above, in the described embodiment(s), antennas in shapes appropriate for different frequency bands are superposed on each other in the RFID tag, and interference of electromagnetic waves is prevented with a spacer or coating. Therefore, an RFID tag that accepts a plurality of frequency bands and provides sufficient performance in a compact size can be provided. Moreover, the RFID tag is failure-safe, because it includes a plurality of antennas and a plurality of RFID chips. Thus, reliability is enhanced.

In the described embodiment, an RFID chip is provided corresponding to each antenna. However, according to an aspect of the present invention, a plurality of antennas can share a single RFID chip. According to an aspect of the present invention, an IC of a tag comprises a plurality antenna contacts corresponding to a plurality of antennas.

As described above, a non-contact IC tag, such as an RFID tag (passive and non-passive (active) RFID tag), and an antenna arranging method according to the present invention are useful when the non-contact IC tag needs to accept a plurality of electromagnetic spectrum frequency bands, and particularly when the non-contact IC tag needs to provide sufficient performance by supporting a plurality of electromagnetic spectrum frequency bands in a compact size. According to the embodiments described herein, a non-contact integrated circuit (IC) data read/writable tag accepts a plurality of frequency bands and provides sufficient performance in a compact size by freely arranging a plurality of antennas (including corresponding IC(s) as the case may be) therein such that the antennas occupy a minimum area with respect to the antennas and by preventing interference between/among the antennas with an insulator. According to an aspect of the invention, a circuit can by any form or type of circuit. According to an aspect of the invention, the arranging comprises forming an inlay by superposing the plurality of antennas and the IC(s), and embedding the inlay in a medium to form a non-contact IC tag. The inlay medium can be (in unlimiting examples) a sheet of paper material, a card, a case, a paper label, etc. in known sizes/dimensions. The insulator as a spacer and/or coating enables placing a plurality of non-contact IC tag antennas close to or near each other while preventing mutual interference or electrical coupling between and/or among the antennas. Thus, a mixture of antennas tuned to different frequencies can be stored in a single tag, without deteriorating communication performance of each antenna, because the antennas can be compatible with various shapes of tags and without reducing a degree of freedom in the design of the antenna. According to an aspect of the invention, superposable antennas (including corresponding IC(s) as the case may be) and an insulator form an inlay of a non-contact IC tag to read/write data from/in.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An radio frequency identification (RFID) tag including a plurality of antennas, the RFID tag comprising:
an interference prevention unit that prevents interference between the antennas.

2. The RFID tag according to claim 1, wherein the interference prevention unit provides an insulator between the antennas to prevent the interference between the antennas.

3. The RFID tag according to claim 2, wherein the insulator is made of insulating resin.

4. The RFID tag according to claim 3, wherein the resin is polyethylene terephthalate.

5. The RFID tag according to claim 3 or 4, wherein the insulator is at least 2 mm thick.

6. The RFID tag according to claim 2, wherein the insulator is made of ceramics.

7. The RFID tag according to claim 2, wherein the insulator is made of insulating paper.

8. The RFID tag according to claim 1, wherein the interference prevention unit coats at least one of the antennas with a material that transmits electromagnetic waves of a frequency band to be transmitted and received by the corresponding antenna, to prevent the interference between the antennas.

9. A method, comprising:
arranging a plurality of antennas in an RFID tag; and
providing an insulator between the antennas to prevent interference between the antennas.

10. A method, comprising:
arranging a plurality of antennas in an RFID tag; and
coating at least one of the antennas with a material that transmits electromagnetic waves of a frequency band to be transmitted and received by the corresponding antenna, to prevent interference between the antennas.

11. A method according to claim 9 or 10, wherein the arranging comprises superposing the plurality of antennas in a medium forming the RFID tag.

12. A method according to claim 9,
wherein the insulator is an insulating spacer and/or antenna insulating coating, made of insulating resin, including polyethylene terephthalate type resin, ceramics, paper, or any combinations thereof, and
the method further comprises:
controlling a thickness of the insulator according to a dielectric constant of the insulator material.

13. An apparatus, comprising:
one or more integrated circuits (IC) to read/write data;
two or more antennas each accepting different electromagnetic spectrum frequency bands and communicably contacting the at least one IC;
a medium on which the one or more ICs and the two or more antennas are superposed; and
one or more insulators between and/or among the antennas to prevent electromagnetic interference between and/or among the antennas.

14. An apparatus according to claim 13, wherein the one or more ICs are passive and the two or more antennas are radio frequency antennas, the ICs and the antennas are inlayed according to a superposing arrangement on the medium to occupy a minimum area with respect to the antennas.

15. An apparatus according to claim 13, wherein a single IC comprises a plurality of antenna contacts that correspond to the two or more antennas.

16. An apparatus according to claim 13, wherein the at least one IC is passive, active, or any combinations thereof.

17. An apparatus according to any one of claims 13 to 16, wherein the insulator is an electromagnetic spectrum insulating spacer and/or antenna coating, made of insulating resin, including polyethylene terephthalate type resin, ceramics, paper, or any combinations thereof.

18. An apparatus according to any one of claims 13 to 16, wherein the two or more differing electromagnetic spectrum frequency band antennas comprise radio frequency antennas of high frequency (HF) band, ultra high frequency (UHF) band and microwave band.

19. An apparatus according to claim 18, wherein the (HF) antenna is a coil type antenna and the UHF and microwave antennas are dipole type antennas.

20. An apparatus according to claim 19,
wherein the insulator is an electromagnetic spectrum insulating spacer made of insulating resin, including polyethylene terephthalate type resin, ceramics, paper, or any combinations thereof, and
wherein the insulating spacer is arranged between the coil antenna for the HF band and the dipole antenna for the UHF band, and between the coil antenna for the HF band and the dipole antenna for the microwave band.

21. An apparatus according to claim 19,
wherein the insulator is an electromagnetic spectrum antenna insulating coating made of insulating resin, including polyethylene terephthalate type resin, ceramics, paper, or any combinations thereof, and
wherein the antenna insulating coating coats the coil antenna for the HF band.

22. An apparatus according to claim 13,
wherein the two or more differing electromagnetic spectrum frequency band antennas comprise radio frequency antennas of high frequency, ultra high frequency and microwave,
wherein the insulator is an antenna coating made of material that transmits electromagnetic waves of high frequency and blocks electromagnetic waves of ultra high frequency and microwave.
